(19) United States
(12) Patent Application Publication
(10) Pub. No.: US 2013/0048426 A1
(43) Pub. Date: Feb. 28, 2013

(54) Grain Rescue Apparatus and Method of Rescue

(71) Applicant: Dale Ekdahl, Elbow Lake, MN (US)

(72) Inventor: Dale Ekdahl, Elbow Lake, MN (US)

(21) Appl. No.: 13/588,397

(22) Filed: Aug. 17, 2012

Related U.S. Application Data
(60) Provisional application No. 61/526,745, filed on Aug. 24, 2011.

(51) Int. Cl. A62B 15/00; B23P 11/00

(52) U.S. Cl. 182/48; 29/428; 29/525

(57) ABSTRACT

A rescue device for assisting in removing an individual from a particulate collapsed space comprising rectangular sheets having four sides with one longitudinal side having a male connector and the other longitudinal side having female connector. The sheets fit together by the female connector on one sheet sliding over the male connector on another sheet. The sheets can be individually inserted into the particulate, connecting one sheet at a time, this making it easier to create a rescue cavity. The sheets connect and are adapted to curl around so as to selectively create a rescue cavity of a desired size.

### RELATED APPLICATIONS

Provisional Filed Aug. 24, 2011 Application 61/526,745

### FEDERALLY SPONSORED RESEARCH

N/A

### SEQUENCE LISTING OR PROGRAM

N/A

### BACKGROUND OF INVENTION

Farming accidents can occur during the removal of grain or seed (or any particulate such as sand, seed, etc . . . ) from bins and silos. When grain flowing out of a silo is not properly funneling out of the silo and/or becomes lodged in the exit chute a person may step on the grain to force it into the exit chute. When the grain becomes unlodged from the exit chute this may result in a rapid expulsion of grain through the chute and out of the silo. When this occurs the person stepping on the grain can be sucked downward into the rapidly exiting grain and become trapped.

When a person becomes trapped in a grain silo it is desirable to remove them from the silo as soon as possible. If a person is not removed the person can suffocate and/or pulled further into the grain.

There are several inventions which exist for assisting in removing a trapped person from a grain silo, including a bottomless barrel which is split in pieces and then assemble inside the silo by attaching the panels of the barrel together. The bottomless barrel is then placed above the trapped person and forced downward into the grain creating a protected area around the individual (rescue cavity) where the grain can then be removed and the person freed.

Also there has been a device comprised of a sheet of metal which is inserted in the silo and then wrapped into a cylinder (shaped like a bottomless barrel) and driven into the grain to create a rescue cavity. The grain is removed from the rescue cavity and the person is removed.

These devices have limitations, including the fact that they must be forced into the grain as a complete unit to encircle the person. Because the units are completely encircling the individual it requires tremendous force to push the unit into the grain.

It is the object of the present invention to provide a rescue device capable of conforming to several sized diameter rescue cavities and capable of sectional insertion in the grain, therefore making it easier to insert and create a rescue cavity around a trapped individual.

The following prior art exists in the field of this invention:

U.S. Pat. No. 6,062,342 to Dobson, filed May 14, 1997. The Dobson patent details a metal sheet which can be wrapped around on its self to create a hollow cylinder. The sheet maybe wrapped around itself at varying amounts to create different sized cylinders depending on the situation.

### BRIEF DESCRIPTION OF THE DRAWINGS

FIG. 1 shows a sheet from the outside with steps for forcing into the grain.

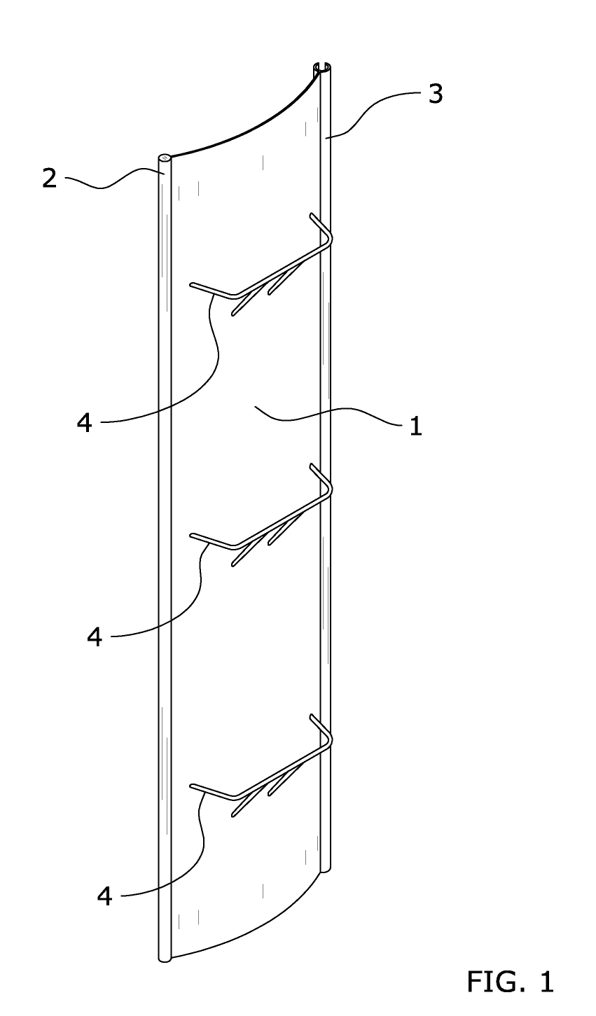

FIG. 2 shows a sheet from the inside, the part facing a trapped person.

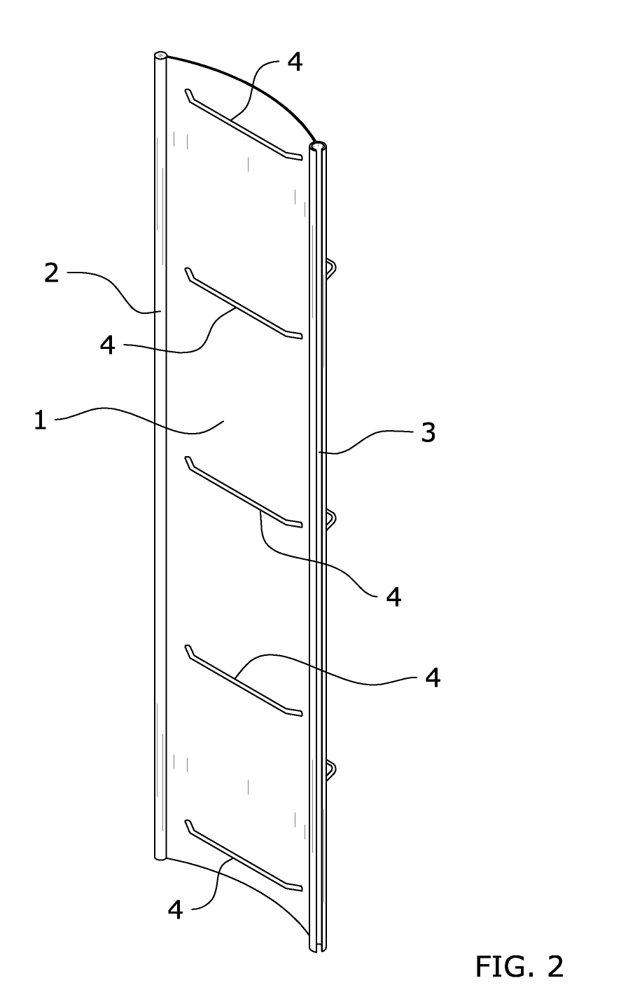

FIG. 3 shows four sheets connected to form a rescue cavity.

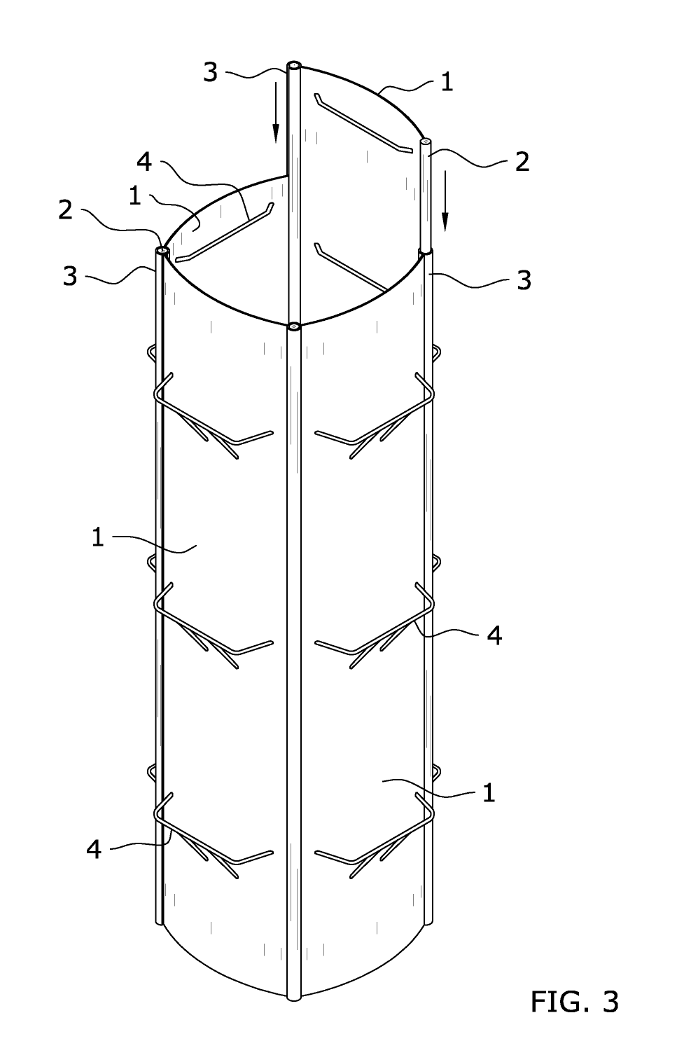

FIG. 4 shows a top view of a sheet.

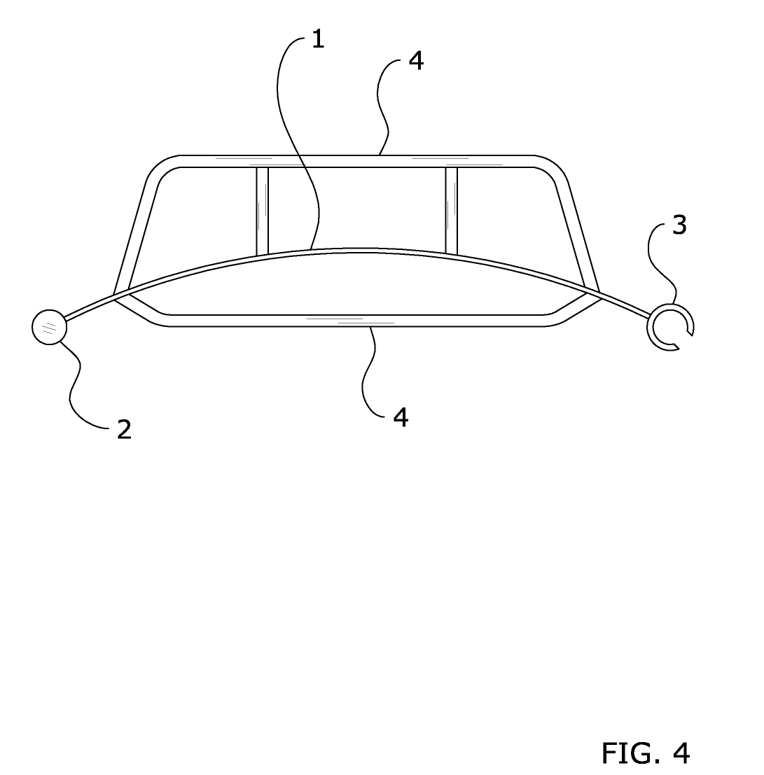

FIG. 5 shows a top view of four sheets connected forming a rescue cavity.

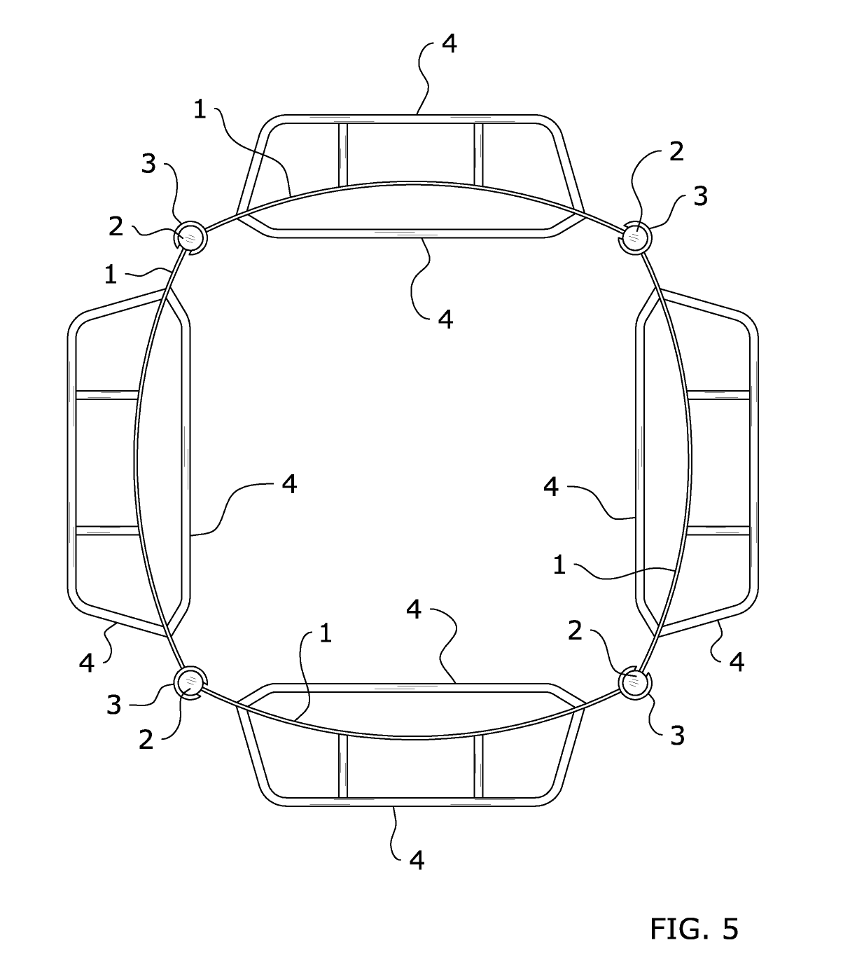

FIG. 6 shows a cut away of a grain bin with a person trapped in the grain.

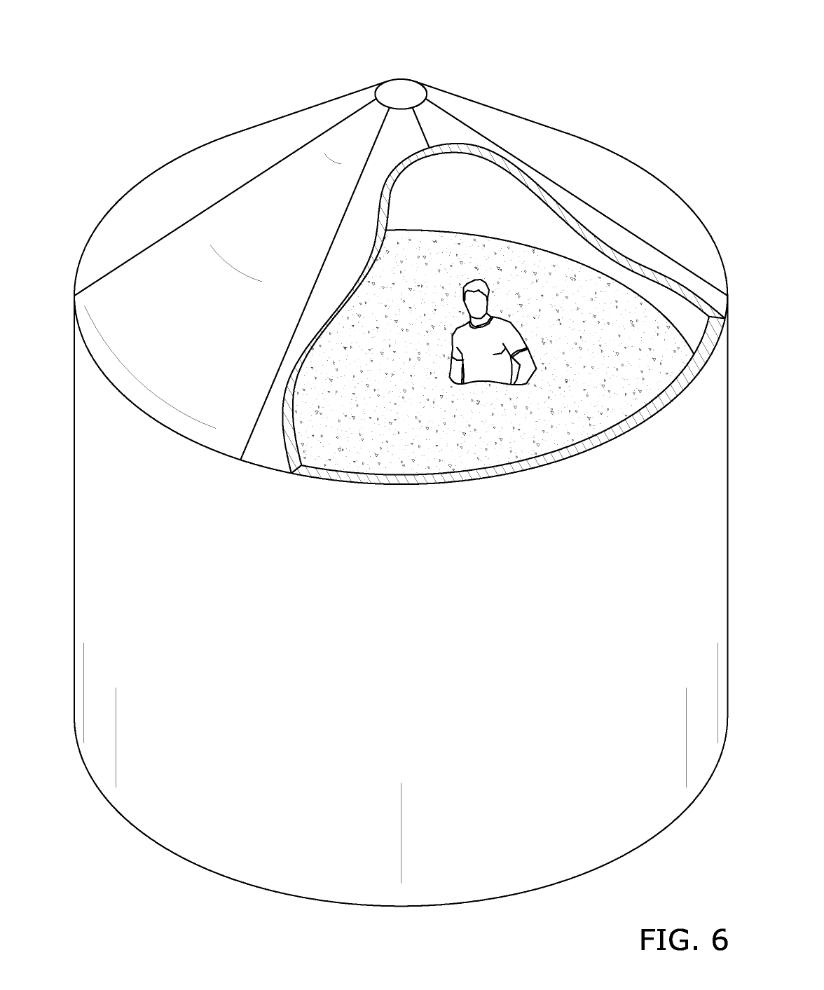

FIG. 7 shows a cut away of a grain bin with a trapped person surrounded by the invention in a rescue cavity.

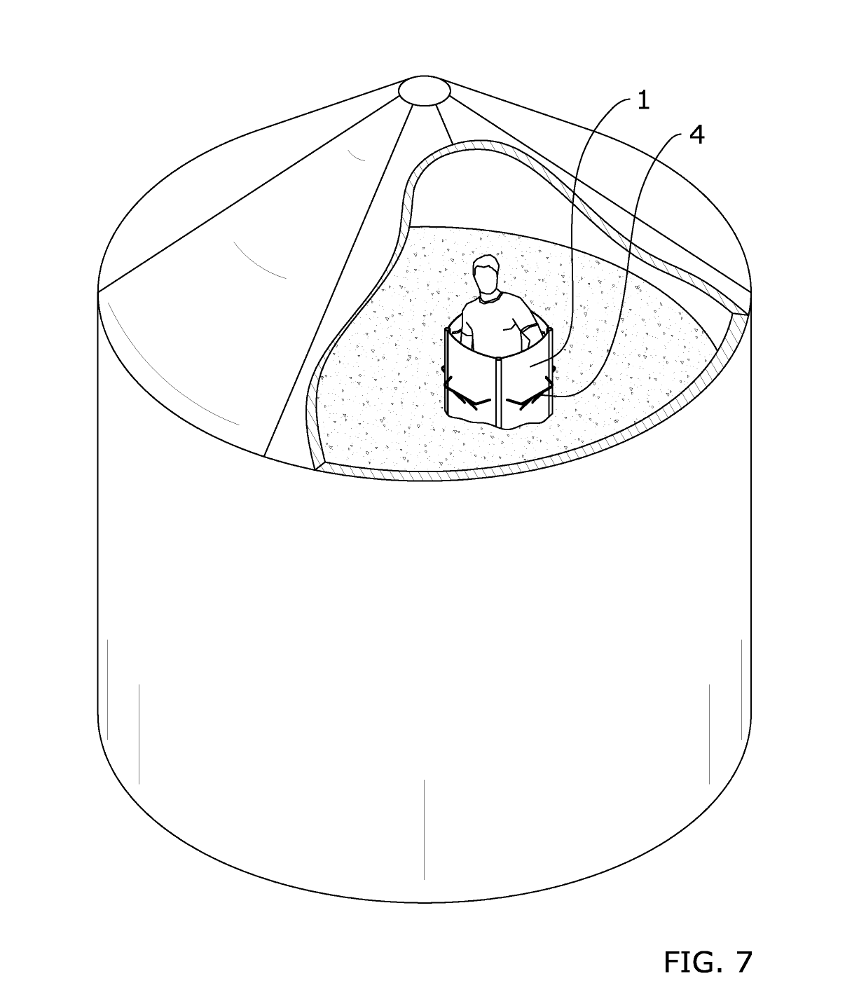

FIG. 8 shows a top view of a trapped person with three sheets forming are rescue cavity with one of the walls of the grain bin.

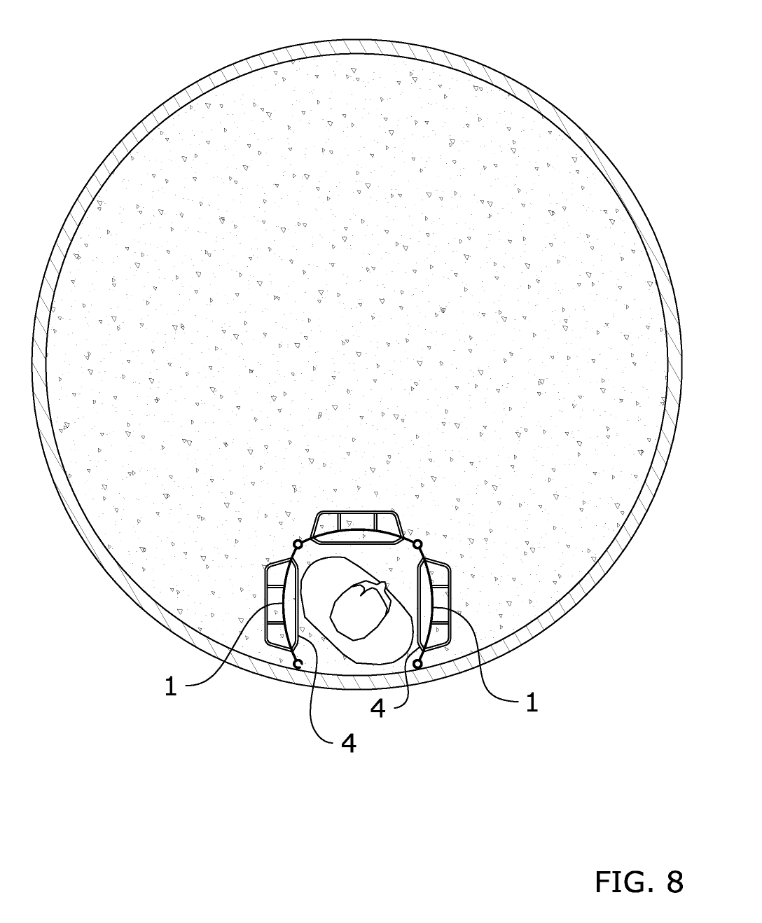

FIG. 9 shows a weight hammer which may be used to force the sheets into the grain.

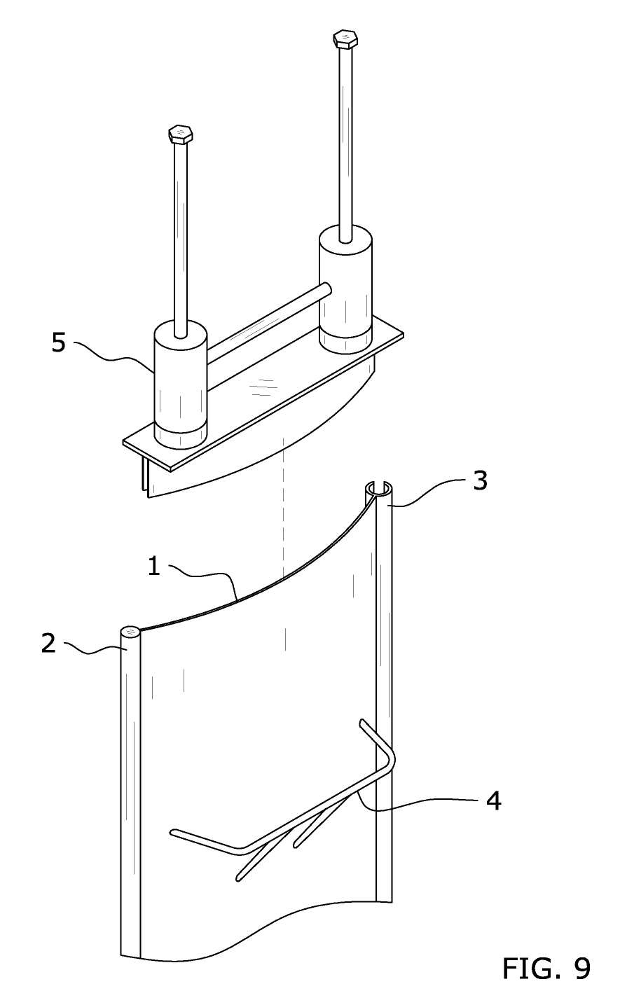

FIG. 10 shows the weight hammer on a sheet being used to force the sheet into the grain.

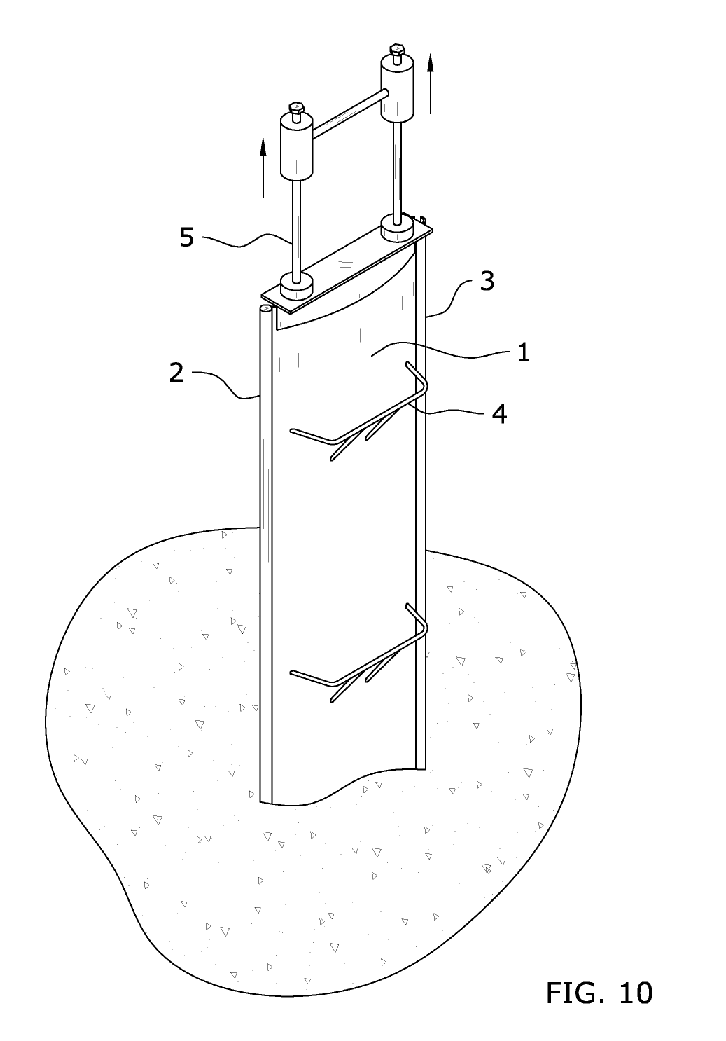

FIG. 11 shows the weight hammer on a sheet being used to force the sheet into the grain.

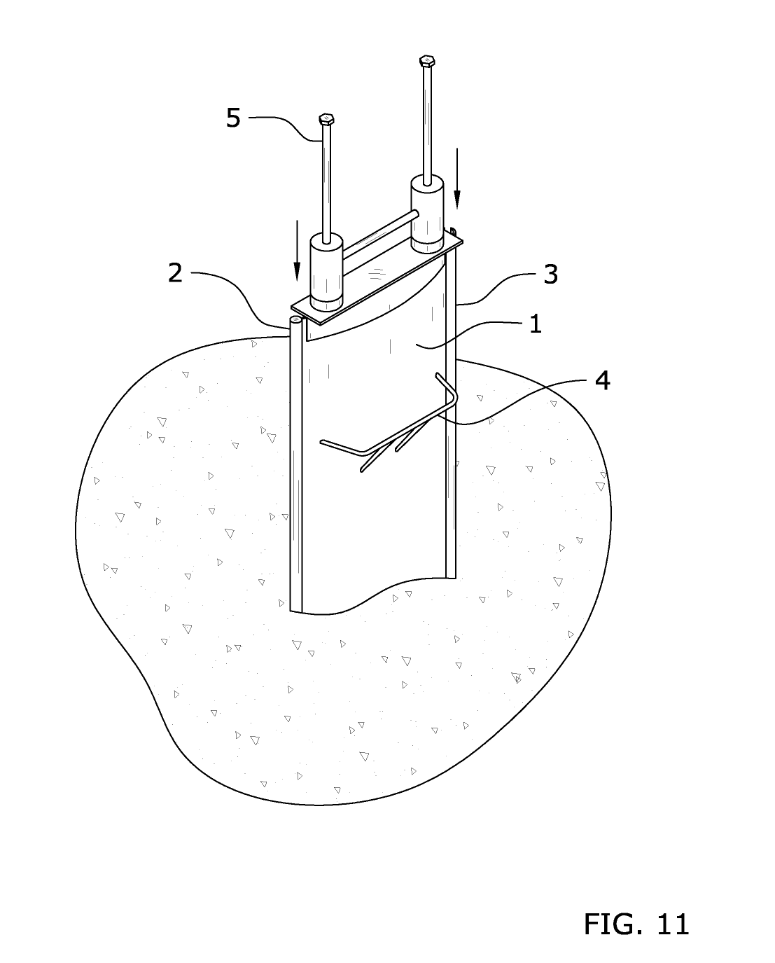

### SUMMARY OF THE INVENTION

The present invention consists of a series of curved sheets which can interlock into a generally circular shape. Each sheet has a “step” or a series of steps connected to the outside of the sheet (the convex side) which is used by rescuers to step on and force the panel into the grain. The interlock between the sheets is flexible, allowing for the sheets to form shapes around trapped individuals as needed and not constrained to perfect circles.

Additionally a weight hammer can be attached to the top of a sheet and used to pound the sheet into the grain.

If a person is trapped in a grain silo, each sheet is forced into the grain one sheet at a time, starting with one sheet, then sliding the interlocking edge of the next sheet over the already inserted sheet and then driving that sheet into the grain and proceeding in this manner until a rescue cavity is formed around the trapped person. Then the grain is removed from the rescue cavity and the person is rescued from the grain.

### DETAILED DESCRIPTION

The invention consists of two main components, concave sheets (1) which interlock and form a rescue cavity and a weight hammer (5) which can drive the concave sheets into the grain.

The concave sheets consist of a piece of material which is rigid and can be forced into a silo/pile/container of grain. The material can be of varying size, but generally the sheet of material is approximately 3-6 feet in length and 15-30 inches wide. The sheet is curved lengthwise so the curvature is approximately 2-4 inches. The sheet has four edges, two of which are the lengthwise edges. On one of these edges a “C” shaped (female) connector (3) running the length of the sheet, and on the opposite lengthwise edge is a circular (male) connector (2) running the length of the sheet which is of a diameter that fits inside the “C” of the female connector (3).

The concave sheets may also have steps (4) attached to the outside (convex) side of the sheet (1). These steps (4) are used to force the sheet into the grain. If someone is trapped in grain in a silo, a rescuer can stand on the steps (4) using the rescuer's weight to push the concave sheet (1) into the grain.

Once the first concave sheet (1) is in the grain, the male connector (2) on the lengthwise side of another concave sheet is fit into the female connector (3) on the concave sheet (1) which is already in the grain, and it is forced into the grain. As the new concave sheet is forced into the grain, the male connector (2) slides down the female connector (3), forming two concave sheets connected to each other. This process continues with additional concave sheets until a rescue cavity forms around the trapped individual. The grain contained in the rescue cavity can then be extracted and the trapped individual safely removed.

Because of the interlocking mechanism between the sheets (“c” shaped female with an “O” shaped male connector) the sheets fit together with flexibility. The “C” female connector allows the adjacent sheet be positioned at varying angles. Because the sheets can fit together at varying angles, this allows many rescue cavity shapes to be formed; not constrained to only circles.

The weight hammer (5) consists of a curved slot which the top of the concave sheet fits inside, on the opposite side of the curved slot are two or more rods which extend away from the curved slot between 2-4 feet. These rods have weights which encompass the rods and can slide up and down the rods. The concave sheets are positioned into the curved slot on the weight hammer and the weights are raised up the rods and released, gravity pulls the weights down slamming the concave sheet into the grain.

The Method for rescuing someone trapped grain starts by taking one concave sheet (1) and either using the attached steps (4) on the sheet to drive the sheet (1) down into the grain, or using the weight hammer (5) to drive the concave sheet (1) down. Next a second concave sheet (1) is fit into or over the adjacent side connection on the sheet previously driven into the grain. This second sheet is then forced in the same manner as the previous concave sheet, into the grain while the edges are connected through the male/female connectors. This process continues until the trapped individual is surrounded by concave sheets, forming a rescue cavity. Grain is then scooped or sucked from the rescue cavity freeing the trapped individual.

It should be noted that this invention is not limited to only grain and any type of particulate which is stored in a storage bin may trap a person, this invention would be useful.

1. A device for creating a rescue cavity around a person who has been trapped by particulate in a particulate accumulation comprising;
a) multiple curved sheets of ridged material having a longitudinally extending direction comprising: a longitudinal axis; an axis of curvature about which the panel is curved, the axis of curvature being substantially perpendicular to the longitudinal axis;
b) running along one of the longitudinal sides of a ridged sheet is a male connecter;
c) opposite the male connecter and running along the other longitudinal side of the ridged sheet is a female connecter;
d) multiple sheets can be slid together by sliding a male connector longitudinally into a female connector.

2. A device as in claim 1 further comprising of the male and female connectors whereas the space provided in the female connector allows for the male and female joint to swivel up to 180 degrees relative to each curved sheet.

3. A device as in claim 2 further comprising
a) a strike surface at one end of the curved sheets;
b) a removable weight hammer which moves in the longitudinal direction to and from the strike surface.

4. A method off quickly rescuing a person who has been trapped by particulate in a particulate accumulation comprising;
a) forcing a curved sheet of ridged material having a longitudinally extending direction comprising: a longitudinal axis; an axis of curvature about which the panel is curved, the axis of curvature being substantially perpendicular to the longitudinal axis, into the a particulate near the trapped person;
b) forcing another curved sheet into the particulate next to and a joining the already inserted curved sheet by sliding the female connector on this curved sheet over the male connector on the already inserted curved sheet;
c) continuing forcing curved sheets into the particulate joining already inserted curves sheets unit a barrier has created a rescue cavity around the trapped person;
d) remove the particulate within the rescue cavity surrounding the trapped person;
e) when enough particulate has been removed from the rescue cavity, extract the trapped person.

5. A method as in claim 4 further comprising;
a) using a weight hammer to drive the curved sheets into the particulate.
